(19) United States
(12) Patent Application Publication
(10) Pub. No.: US 2011/0150376 A1
(43) Pub. Date: Jun. 23, 2011

(54) TRUST FOIL BEARING

(75) Inventor: Heon Seok Lee, Daejeon (KR)

(73) Assignee: KTURBO, INC., Cheongwon-gun, Chungbuk (KR)

(21) Appl. No.: 13/060,423

(22) PCT Filed: Aug. 25, 2008
(86) PCT No.: PCT/KR2008/004941

§ 371 Date: Feb. 23, 2011

(51) Int. Cl. F16C 32/06

(52) U.S. Cl. 384/105

(57) ABSTRACT

The present invention relates to a thrust foil bearing comprising a plurality of bumps, and a plurality of top foils, wherein a plurality of cut portions is formed radially on the base in such a manner as to be extended by a predetermined length toward the outer circumference of the bearing from the inner circumference of the bearing, thereby providing excellent stability against heat.

### TECHNICAL FIELD

The present invention relates to a thrust foil bearing that prevents the temperature at the inner circumference thereof from being higher than the temperature at the outer circumference thereof by the generation of heat from a shaft itself when heat is generated from the inner circumference of the thrust foil bearing abutting against a radial bearing, thereby avoiding its deformation to a cone-like shape due to a failure in maintaining a plane.

### BACKGROUND ART

A bearing is largely classified into a rolling bearing (using a ball or a roller), an oiless bearing (which is operated frictionally by using a material having lubricity), a sliding bearing (using oil), a gas bearing, and a magnetic bearing (which is operated contactlessly by using a magnetic force).

The sliding bearing is divided into a dynamic sliding bearing and a static sliding bearing, wherein the dynamic bearing serves to support a shaft through the generation of pressure from oil by means of relative sliding movements and the static bearing serves to support a shaft through the supply of high pressure oil from the outside.

The gas bearing is operated in the same principle as that of the sliding bearing, except that gas is used instead of the oil.

If pressurized gas is supplied from the outside, the gas bearing serves as a static gas bearing, and if the pressure from the oil is generated by the relative sliding movements, the gas bearing serves as a dynamic gas bearing.

The dynamic gas bearing is widely used in a high-speed rotation application owing to the advantages of the generation of small friction loss and the unnecessary liquid lubricant oil, and especially, the dynamic gas bearing is generally used in a super-high-speed rotation application wherein it is difficult to support the shaft by means of the rolling bearing as well as in other applications wherein it is difficult to use the lubricant oil.

The dynamic gas bearing is divided again into a grooved bearing, a tilt pad bearing, and a foil bearing, wherein the grooved bearing has a groove formed thereon to generate a pressure, a representative example of which is a spiral grooved bearing.

The hydrodynamic fluid-film tilt pad bearing has substantially limited conditions in the practical use thereof. Thus, if the conditions are not satisfied during the use, it may be disadvantageously damaged.

For example, if the tilt pad bearing is operated either under the conditions exceeding the design conditions or under the conditions not reaching the design conditions, it shows drastically decreased stiffness such that it is very susceptible to impacts, the misalignment of a shaft, and thermal deformation.

The foil bearing called a compliant hydrodynamic fluid-film bearing has absolutely excellent performances as compared to a fixed type tilt pad bearing, which has been remarkably evolved for 20 years. It has been found that the foil bearing has good durability and stability in an air conditioning system of an airplane, and particularly, it is used in a high-speed rotation machine like a ultra cryogenic turbo compressor rotating at tens of thousands RPM.

The foil bearing is usable even in a condition where a little liquid is mixed and advantageously has flexibility and the possibility of low cost.

The foil bearing in the aviation field has been mainly used in an air cooling machine (ACM) as a main component for adjusting the pressure and temperature in a cabin in an environmental control system (ECS) since 1970, which is the most appropriate example in the practical use thereof.

The foil bearing in the aviation field does not have any oil system, which does not pollute the inside of the cabin and makes a stable operation achieved for a substantially long period of time when compared with the ball bearing without a fixed repairing schedule.

Further, the components of the turbo are not almost damaged even when the foil bearing is broken, and therefore, the foil bearing used in a Boeing 747 aircraft can be used for tens of thousands hours or more without any repair.

The foil bearing is largely divided into two types. The first type is a leaf type foil bearing which has a plurality of foils partially superposed on each other in a rotating direction to support a shaft, and the second type is a bump type foil bearing which has one entire foil and a spring having various shapes mounted on the outside of the foil so as to support the foil, as shown in FIG. 1.

The leaf type foil bearing is applicable in case where support load is small and an external impact is weak, and it disadvantageously has a large activation torque.

Contrarily, the bump type foil bearing is known as having a small load upon activation and excellent durability and stiffness. However, it is difficult to design and produce the bump type foil bearing, and especially, it is difficult to secure the stability such that the technology on the bump type foil bearing is possessed just by two or three companies over the world.

The technical content related to the bump type thrust foil bearing is disclosed in PCT International Publication No. WO 2006/036570 (dated on Apr. 6, 2006).

A plurality of bump foils serving as a spring is welded at the inside of a bearing housing, and a plurality of top foils abutting against a shaft (or a journal) at the inside of the bump foils are welded to the bearing housing.

If the shaft is rotated and passed with air, the top foils and the bump foils are deformed, while creating a predetermined space for defining a fluid film supporting the load therein.

The geometric shape for forming the fluid film on the foil bearing is provided by the elastic deformation of the top foils.

As the number of rotations is increased, the top foils and the bump foils are pushed outwardly, and thus, if the shaft is deviated from the center, a converging wedge-shaped space is formed.

At this time, since the top foils are deformed on the foil bearing, it is possible to obtain an optimal shape wherein an appropriate dynamic pressure is generated by the minute deformation of the top foils through good designing, without any complicate machining.

Also, since a clearance is generated in the radial direction, it is possible to cope with an increase in the diameter of the shaft according to high-speed rotation can be handled.

Furthermore, a military bearing needs the performance capable of enduring high-speed rotation and poor environment and impact, and a general oil lubricating bearing in a high- speed, high-output, high-efficiency motor does not provide any demanded performances.

The thrust foil bearing is implemented on the plane on a basis of the same principle as that of the radial foil bearing, and also, it is known that the thrust foil bearing is more susceptible to thermal deformation than the stability of rotation.

### DISCLOSURE OF INVENTION

### Technical Problem

Accordingly, the present invention has been made in view of the above-mentioned problems occurring in the prior art, and it is an object of the present invention to provide a thrust foil bearing that prevents the temperature at the inner circumference thereof from being higher than the temperature at the outer circumference thereof by the generation of heat from a shaft itself when heat is generated from the inner circumference of the thrust foil bearing abutting against a radial bearing, thereby avoiding its deformation to a cone-like shape due to a failure in maintaining a plane.

### Technical Solution

To achieve the above object, according to the present invention, there is provided a thrust foil bearing comprising a base, a plurality of bumps, and a plurality of top foils, wherein a plurality of cut portions is formed radially on the base in such a manner as to be extended by a predetermined length toward the outer circumference of the bearing from the inner circumference of the bearing.

### Advantageous Effects

According to the present invention, there is provided the thrush foil bearing that provides the plurality of cut portions formed radially on the base so as to secure a predetermined space in the rotating direction capable of protecting the thermal expansion of the inner circumference thereof, thereby preventing axial deformation and providing a stable operation even at a substantially high temperature.

### BRIEF DESCRIPTION OF THE DRAWINGS

FIG. 1 is a perspective view showing a conventional thrust foil bearing.

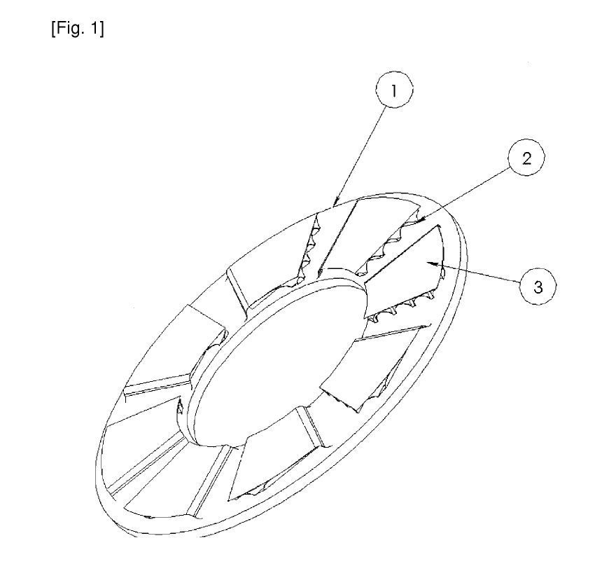

FIG. 2 is a perspective view showing an improved thrust foil bearing according to the present invention.

### MODE FOR THE INVENTION

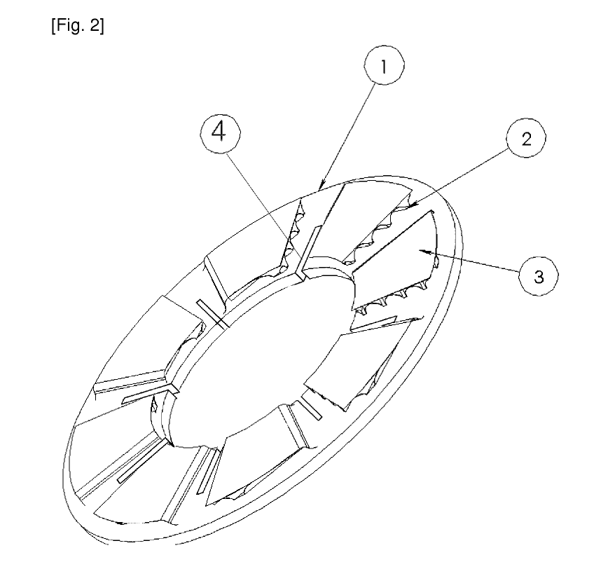

As shown in FIG. 2, a bump type thrust foil bearing according to the present invention includes a base 1, a plurality of bumps 2, and a plurality of top foils 3, as main parts thereof, in the same manner as in the conventional art.

According to the present invention, further, the thrust foil bearing includes a plurality of cut portions 4 formed on the base 1.

The plurality of cut portions 4 serves to have a predetermined space defined on the inner circumference of the base 1, thereby preventing the bearing from being deformed in a direction of a shaft.

Such a cut portion is mounted in plural numbers on the base 1, and an appropriate number of cut portions 4 may be formed on the base 1 in consideration of the heating state thereof.

In an embodiment of the present invention, the plurality of cut portions 4 is formed on the base 1 in such a manner that each cut portion is arranged between two adjoining top foils.

Also, it is possible to vary the length of each cut portion 4 according to the thickness of the base 1 and the use state of the bearing.

When the base 1 is made thick, the thermal deformation can be minimized by the thick base 1 itself. But if the entire thickness of the bearing becomes large, the length of the shaft is extended, thereby contributing to a degradation in the stability of the shaft.

Therefore, a relatively thin plate needs to be used.

In case where the base 1 is formed of a relatively thin material, however, the base 1 may be deformed by the temperature generated upon the operation to cause the top foils 3 mounted on the base 1 to be deformed, thereby directly damaging the bearing.

Typically, the temperature at the inner circumference of the bearing is higher than that at the outer circumference thereof. That is, the temperature of the bearing becomes decreased as it goes toward the outer circumference of the bearing.

This is because the parts emitting heat are positioned at the outside of the bearing and because the shaft rotated at a high speed is positioned at the inside of the bearing.

As the heat is generated, the inner circumferential length of the bearing becomes more increased than the outer circumferential length thereof, such that the bearing is deviated from the plane in a direction of a thickness thereof.

According to the present invention, therefore, the plurality of cut portions 4 that are formed radially on the base 1 compensate for the deformed circumferential length of the bearing, thereby preventing the bearing from being damaged or broken.

1. A thrust foil bearing comprising:
a base;
a plurality of bumps; and
a plurality of top foils;
wherein a plurality of cut portions is formed radially on the base in such a manner as to be extended by a predetermined length toward the outer circumference of the bearing from the inner circumference of the bearing; and
wherein the plurality of cut portions is formed on the base in such a manner that each cut portion is arranged between two adjoining top foils.

2. (canceled)
